(19) United States
(12) Patent Application Publication
(10) Pub. No.: US 2023/0091719 A1
(43) Pub. Date: Mar. 23, 2023

(54) CODE EXECUTION RECORDING VISUALIZATION TECHNIQUE

(71) Applicant: Metawork Corporation, Atherton, CA (US)

(72) Inventors: Nicholas DeMonner, Corvallis, OR (US); William Tachau, Berkeley, CA (US); David Michael Renie, Atherton, CA (US); Justin Mezzell, Orlando, FL (US)

(21) Appl. No.: 17/482,836

(22) Filed: Sep. 23, 2021

(51) Int. Cl. G06F 11/36

(52) U.S. Cl. CPC G06F 11/3664; G06F 11/3644

(57) ABSTRACT

A visualization technique provides a user interface (UI) configured to display a recording of code execution in an intuitive manner that allows a user to walk-through and visually render the recorded code execution. The recording includes trace and application data embodied as one or more frames corresponding to invocations of code and associated values as captured during code execution. The UI displays the captured recording of code execution in the form of a call graph that illustrates the frames along with their corresponding methods and values, in context. By selecting a frame, the execution of code may be visualized on the UI in an organized manner across different methods invoked during execution of the code. The UI visualization feature of the technique provides a user with a concrete representation of code execution in an organized flow that enables the user to walk-through the recording in the same manner in which the code was executed.

### BACKGROUND

### Technical Field

The present disclosure relates to software application development and production and, more specifically, to an investigative platform having tools configured to record execution of software applications (code) and diagnose and solve errors associated with software application development and production.

### Background Information

Conventional observability tools are typically used in both software development and production environments to infer internal states of an executing software application (e.g., executable code) from knowledge of external outputs. However, these tools generally have a limited view/observation of information for a user (software developer) to obtain sufficient information (e.g., internal state information) about executable code to accurately understand behavior of execution to inform new development, as well as correctly diagnose a malfunction. Indeed, these observability tools only provide software developers with the limited ability to view or observe unencumbered actual code execution in a target environment. That is, these tools enable users to observe an abstraction (“proxy”) of code execution that is typically limited to predetermined capture points and values provided by, e.g., examination of logs and short traces of code, to construct an approximation of code behavior. As a result, an integrated view of sufficient fidelity of actual code execution across the collected information is not possible to aid the malfunction diagnosis or development of new code, especially with respect to a historical view of specific operations manifesting the malfunction. This is further exacerbated by asynchronous code execution which is a widely used feature of many runtime systems. For example, the tools may capture exceptions raised by the executable code that indicate a malfunction, but the root cause may be buried in a history of specific data values as well as synchronous and asynchronous processing leading to the exception. As such, a lack of accurate and complete history of invocations and data changes across the collected information hinders efficient and successful diagnosis of the malfunction, because actual behavior of the invocations and data changes is lacking in traditional observability tools that only allow for inferring internal states of software from inadequate or incomplete data. As such, examination is challenging because existing tools do not capture precise code execution with associated data.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a virtualized computing environment;

FIG. 2 is a block diagram of the virtual machine instance;

FIG. 3 is a block diagram of an investigative platform;

FIG. 4 illustrates a workflow for instrumenting executable code using a dynamic configuration; and

FIGS. 5A-5C are screenshots of a user interface (UI) embodiment that displays recordings of code execution on a standard UI in accordance with a code execution recording visualization technique; in particular, FIG. 5A depicts a UI embodiment of synchronously executed code grouped according to sequential order of execution, FIG. 5B depicts a UI embodiment of asynchronously executed code, and FIG. 5C depicts a UI embodiment of synchronously executed code including parameter information.

### OVERVIEW

The embodiments herein are directed to a visualization technique that provides a user interface (UI) configured to display a recording of code execution in an intuitive manner that allows a user to navigate (walk-through according to temporal order or jump according to cross-reference, i.e., skip around) a visual rendering of the recorded code execution. The recording includes trace and application data embodied as one or more frames corresponding to invocations of code (i.e., one or more methods) and associated values (e.g., parameters, exceptions, return values and the like) as captured during code execution. According to the technique, the UI displays the captured recording of code execution in the form of a call graph that visually depicts the frames (i.e., invocation of methods and associated parameters) as corresponding code of the invoked methods and values of the frames, in context and independent of source code layout. That is, the frames representing executed methods (code) are displayed individually with their associated source code and values of parameters at invocation without unnecessary showing of uninvoked, albeit related, code that may reside in a same source code file. Further, frames executed synchronously are visually grouped in a window so that other frames executed asynchronously to the former frames are visually grouped in a different window, which may be dynamically brought up as the user selects the frames (calls). In this manner, by selecting (e.g., clicking on) a frame, the execution of code may be visualized on the UI in an organized manner (e.g., synchronously executed methods grouped by a stack of windows layered according to sequential order of execution) across different methods that were invoked (called) during execution of the code along with their associated call parameters, wherein asynchronously invoked methods are visualized distinctively (e.g., grouped and displayed as a stack of windows). As a result, the UI visualization feature of the technique provides a user with a concrete representation of code execution in an organized flow that enables the user to walk-through and skip around the recording in the same manner in which the code was executed while distinguishing between synchronous and asynchronous code execution.

### DESCRIPTION

The disclosure herein is generally directed to an investigative platform having tools that enable software developers to more efficiently develop software, as well as monitor, investigate, diagnose and remedy errors. In addition, the investigative tools facilitate other deployment issues including code review associated with application development and production. In this context, an application (e.g., a user application) denotes a collection of interconnected software processes or services, each of which provides an organized unit of functionality expressed as instructions or operations, such as symbolic text, interpreted bytecodes, machine code and the like, which is defined herein as executable code and which is associated with and possibly generated from source code (i.e., human readable text written in a high-level programming language) stored in repositories. The investigative platform may be deployed and used in environments (such as, e.g., production, testing, and/or development environments) to facilitate creation of the user application, wherein a developer may employ the platform to provide capture and analysis of the operations (contextualized as “recordings”) to aid in executable code development, debugging, performance tuning, error detection, and/or anomaly capture managed by issue.

In an exemplary embodiment, the investigative platform may be used in a production environment which is executing (running) an instance of the user application. As described further herein, the user application cooperates with the platform to capture a recording of code execution that includes traces (e.g., timing information such as call duration, entry/exit timestamps and the like) as well as application execution information (e.g., execution of code and associated data/variables) used to determine the cause of errors, faults and inefficiencies in the executable code and which may be organized by issue typically related to a common root cause. Notably, a call graph 180 may be constructed from the recording to aid visualization. To that end, the investigative platform may be deployed on hardware and software computing resources, ranging from laptop/notebook computers, desktop computers, and on-premises (“on-prem”) compute servers to, illustratively, data centers of virtualized computing environments.

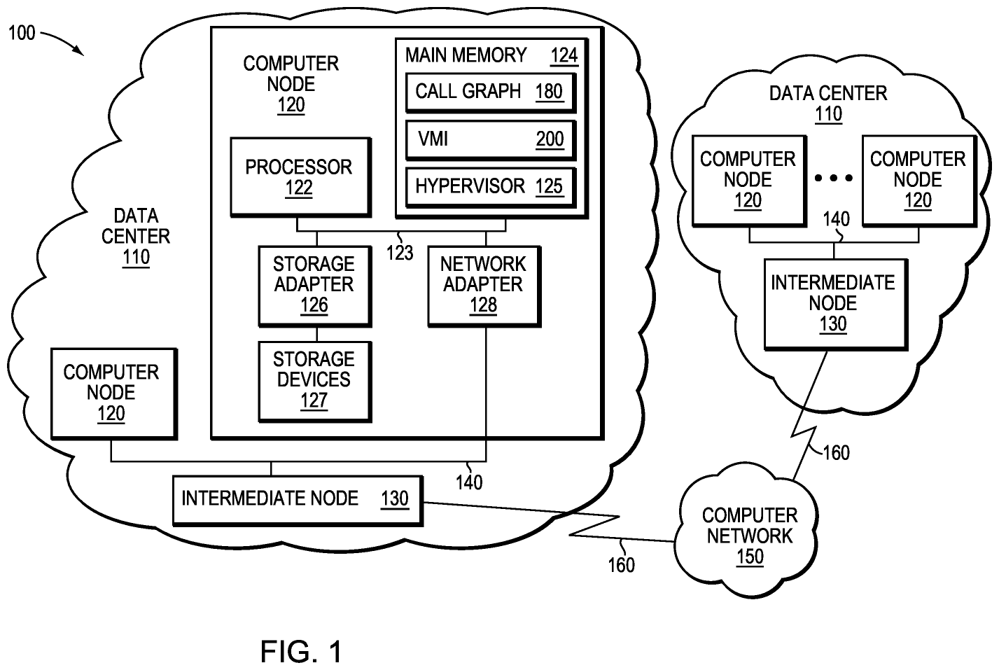

FIG. 1 is a block diagram of a virtualized computing environment 100. In one or more embodiments described herein, the virtualized computing environment 100 includes one or more computer nodes 120 and intermediate or edge nodes 130 collectively embodied as one or more data centers 110 interconnected by a computer network 150. The data centers may be cloud service providers (CSPs) deployed as private clouds or public clouds, such as deployments from Amazon Web Services (AWS), Google Compute Engine (GCE), Microsoft Azure, typically providing virtualized resource environments. As such, each data center 110 may be configured to provide virtualized resources, such as virtual storage, network, and/or compute resources that are accessible over the computer network 150, e.g., the Internet. Each computer node 120 is illustratively embodied as a computer system having one or more processors 122, a main memory 124, one or more storage adapters 126, and one or more network adapters 128 coupled by an interconnect, such as a system bus 123. The storage adapter 126 may be configured to access information stored on storage devices 127, such as magnetic disks, solid state drives, or other similar media including network attached storage (NAS) devices and Internet Small Computer Systems Interface (iSCSI) storage devices. Accordingly, the storage adapter 126 may include input/output (I/O) interface circuitry that couples to the storage devices over an I/O interconnect arrangement, such as a conventional peripheral component interconnect (PCI) or serial ATA (SATA) topology.

The network adapter 128 connects the computer node 120 to other computer nodes 120 of the data centers 110 over local network segments 140 illustratively embodied as shared local area networks (LANs) or virtual LANs (VLANs). The network adapter 128 may thus be embodied as a network interface card having the mechanical, electrical and signaling circuitry needed to connect the computer node 120 to the local network segments 140. The intermediate node 130 may be embodied as a network switch, router, firewall or gateway that interconnects the LAN/VLAN local segments with remote network segments 160 illustratively embodied as point-to-point links, wide area networks (WANs), and/or virtual private networks (VPNs) implemented over a public network (such as the Internet). Communication over the network segments 140, 160 may be effected by exchanging discrete frames or packets of data according to pre-defined protocols, such as the Transmission Control Protocol/Internet Protocol (TCP/IP) and the User Datagram Protocol (UDP), although other protocols, such as the OpenID Connect (OIDC) protocol, the HyperText Transfer Protocol Secure (HTTPS), HTTP/2, and the Google Remote Procedure Call (gRPC) protocol may also be advantageously employed.

The main memory 124 includes a plurality of memory locations addressable by the processor 122 and/or adapters for storing software programs (e.g., user applications, processes and/or services) and data structures (e.g., call graph 180) associated with the embodiments described herein. As used herein, a process (e.g., a user mode process) is an instance of a software program (e.g., a user application) that may be decomposed into a plurality of threads executing in the operating system. The processor and adapters may, in turn, include processing elements and/or circuitry configured to execute the software programs, including an instance of a virtual machine and a hypervisor 125, and manipulate the data structures. The virtual machine instance (VMI) 200 is managed by the hypervisor 125, which is a virtualization platform configured to mask low-level hardware operations and provide isolation from one or more guest operating systems executing in the VMI 200. In an embodiment, the hypervisor 125 is illustratively the Xen hypervisor, although other types of hypervisors, such as the Hyper-V hypervisor and/or VMware ESX hypervisor, may be used in accordance with the embodiments described herein. As will be understood by persons of skill in the art, in other embodiments, the instance of the user application may execute on an actual (physical) machine.

It will be apparent to those skilled in the art that other types of processing elements and memory, including various computer-readable media, may be used to store and execute program instructions pertaining to the embodiments described herein. Also, while the embodiments herein are described in terms of software programs, processes, threads, services and executable code stored in memory or on storage devices, alternative embodiments also include the code, services, processes and programs being embodied as logic, components, and/or modules consisting of hardware, software, firmware, or combinations thereof.

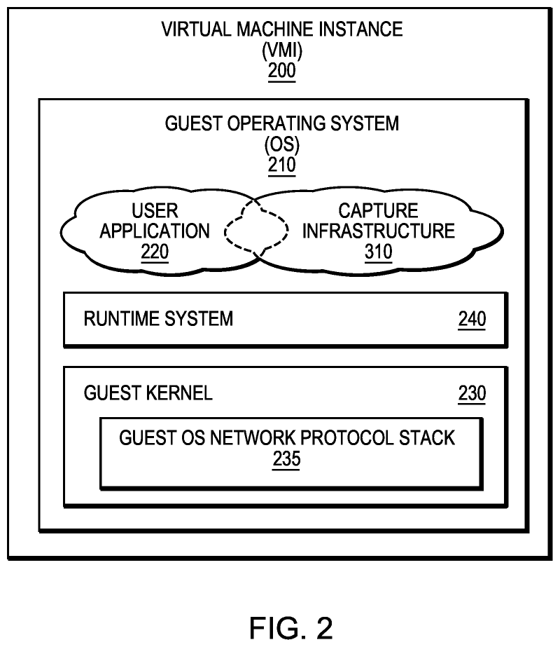

FIG. 2 is a block diagram of the virtual machine instance (VMI) 200. In an embodiment, guest operating system (OS) 210 and associated user application 220 may run (execute) in the VMI 200 and may be configured to utilize system (e.g., hardware) resources of the data center 110. The guest OS 210 may be a general-purpose operating system, such as FreeBSD, Microsoft Windows®, macOS®, and similar operating systems; however, in accordance with the embodiments described herein, the guest OS is illustratively the Linux® operating system. A guest kernel 230 of the guest OS 210 includes a guest OS network protocol stack 235 for exchanging network traffic, such as packets, over computer network 150 via a network data path established by the network adapter 128 and the hypervisor 125. Various data center processing resources, such as processor 122, main memory 124, storage adapter 126, and network adapter 128, among others, may be virtualized for the VMI 200, at least partially with the assistance of the hypervisor 125. The hypervisor may also present a software interface for processes within the VMI to communicate requests directed to the hypervisor to access the hardware resources.

A capture infrastructure 310 of the investigative platform may be employed (invoked) to facilitate visibility of the executing user application 220 by capturing and analyzing recordings of the running user application, e.g., captured operations (e.g., functions and/or methods) of the user application and associated data/variables (e.g., local variables, passed parameters/arguments, etc.) In an embodiment, the user application 220 may be created (written) using an interpreted programming language such as Ruby, although other compiled and interpreted programming languages, such as C++, Python, Java, PHP, and Go, may be advantageously used in accordance with the teachings described herein. Illustratively, the interpreted programming language has an associated runtime system 240 within which the user application 220 executes and may be inspected. The runtime system 240 provides application programming interfaces (APIs) to monitor and access/capture/inspect (instrument) operations of the user application so as to gather valuable information or “signals” from the recording (captured operations and associated data), such as arguments, variables and/or values of procedures, functions and/or methods. A component of the capture infrastructure (e.g., a client library) cooperates with the programming language's runtime system 240 to effectively instrument (access/capture/inspect) the executable code of the user application 220.

As described further herein, for runtime systems 240 that provide first-class support of callback functions (“callbacks”), callbacks provided by the client library may be registered by the user application process of the guest OS 210 when the executable code is loaded to provide points of capture for the running executable code. Reflection capabilities of the runtime system 240 may be used to inspect file path(s) of the executable code and enumerate the loaded methods at events needed to observe and capture the signals. Notably, a fidelity of the captured signals may be configured based on a frequency of one or more event-driven capture intervals and/or a selection/masking of methods/functions to capture, as well as selection/masking, type, degree and depth of associated data to capture. The event-driven intervals invoke the callbacks, which filter information to capture. The events may be triggered by method invocation, method return, execution of a new line of code, raising of exceptions, and periodic (i.e., time based). For languages that do not provide such first-class callback support, a compiler and/or runtime environment may be modified to insert callbacks as “hooks” such that, when processing the executable code, the modified compiler may generate code to provide (or the modified runtime environment may provide) initial signals passed in the callbacks to the client library, as well as to provide results from the callbacks to the client library. In other embodiments, the callbacks may be added at runtime by employing proxy methods (i.e., wrapping invocations of the methods to include callbacks at entry and/or exit of the methods) in the executable code. Moreover, the client library (which is contained in the same process running the user application 220) may examine main memory 124 to locate and amend (rewrite) the executable code and enable invocation of the callbacks to facilitate instrumentation on behalf of the investigative platform.

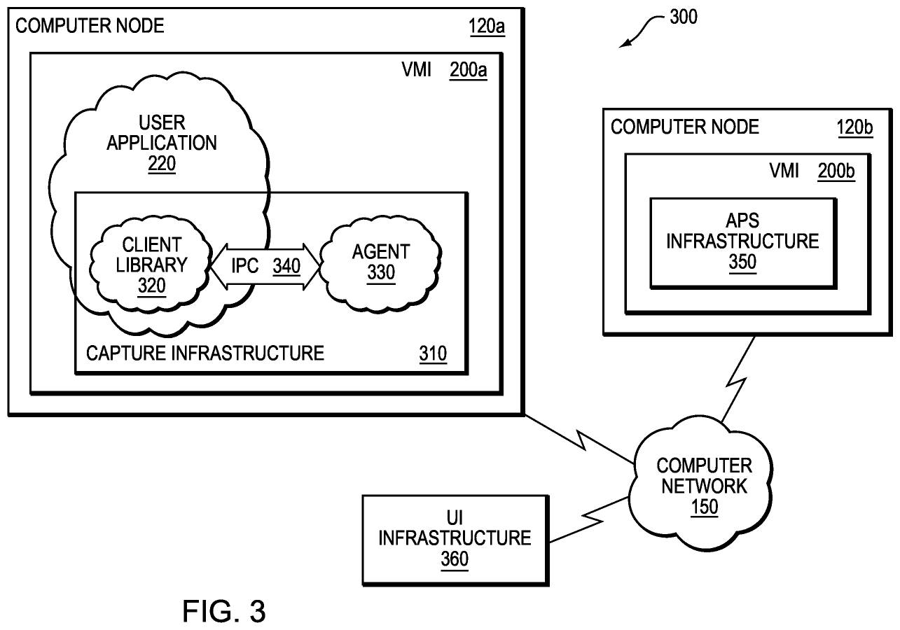

FIG. 3 is a block diagram of the investigative platform 300. In one or more embodiments, the investigative platform 300 includes the capture infrastructure 310 in communication with (e.g. connected to) an analysis and persistent storage (APS) infrastructure 350 as well as a user interface (UI) infrastructure 360 via computer network 150. Illustratively, the capture infrastructure 310 includes a plurality of components, such as the client library 320 and an agent 330, that interact (e.g., through the use of callbacks) to instrument the running executable code visible to the client library, initially analyze recordings (including traces) captured through instrumentation, compress and thereafter send the recordings via the dynamic computer network 150 to the APS infrastructure 350 for comprehensive analysis and storage. The APS infrastructure 350 of the investigative platform 300 is configured to provide further multi-faceted and repeatable processing, analysis and organization, as well as persistent storage, of the captured recordings. The UI infrastructure 360 allows a user to interact with the investigative platform 300 and examine recordings via comprehensive views distilled by the processing, analysis and organization of the APS infrastructure 350. The capture infrastructure 310 illustratively runs in a VMI 200a on a computer node 120a that is separate and apart from a VMI 200b and computer node 120b on which the APS infrastructure 350 runs. Note, however, that the infrastructures 310 and 350 of the investigative platform 300 may run in the same or different data center 110.

In an embodiment, the client library 320 may be embodied as a software development kit (SDK) that provides a set of tools including a suite of methods that software programs, such as user application 220, can utilize to instrument and analyze the executable code. The client library 320 illustratively runs in the same process of the user application 220 to facilitate such executable code instrumentation and analysis (work). To reduce performance overhead costs (e.g., manifested as latencies that may interfere with user application end user experience) associated with executing the client library instrumentation in the user application process, i.e., allocating the data center's processing (e.g., compute, memory and networking) resources needed for such work, the client library queries the runtime system 240 via an API to gather recording signal information from the system, and then performs a first dictionary compression and passes the compressed signal information to an agent 330 executing in a separate process. The agent 330 is thus provided to mitigate the impact of work performed by the client library 320, particularly with respect to potential failures of the user application. Note that in other embodiments, the agent may run on a separate machine.

Illustratively, the agent 330 may be embodied as a process isolated from the user application or as light-weight threads within the user application process. In the former, the agent is spawned as a separate process of the guest OS 210 to the user application 220 and provides process isolation to retain captured recordings in the event of user process faults, as well as to prevent unexpected processing resource utilization or errors from negatively impacting execution of the user application 220; in the latter, the agent may execute as one or more threads within the process of the user application so as to avoid inter-process communication (IPC) overhead at the expense of isolation from negative user application execution. As much processing as possible of the captured recordings of the executable code is offloaded from the client library 320 to the agent 330 because overhead and latency associated with transmission of information (e.g., the captured recordings) between operating system processes is minimal as compared to transmission of the information over the computer network 150 to the APS infrastructure 350. In an embodiment, the client library 320 and agent 330 may communicate (e.g., transmit information) via an Inter Process Communication (IPC) mechanism 340, such as shared memory access or message passing of the captured recording signals. Thereafter, the agent 330 may perform further processing on the captured recordings, such as a second dictionary compression across captured recordings, and then send the re-compressed captured recordings to the APS infrastructure 350 of the investigative platform 300 over the computer network 150 for further processing and/or storage.

The embodiments herein are directed to a technique that provides a user interface (UI) configured to display a recording of code execution in an intuitive manner that allows a user to visually navigate (walk-through and skip around) the recorded code execution. A user links the client library 320 to the user application 220, e.g., after the client library is loaded into a process of the application and, thereafter, the client library (at initialization and thereafter on-demand) loads a dynamic configuration that specifies information such as, inter alia, methods and associated arguments, variables and data structures (values) to instrument as well as a fidelity of capture (i.e., a frequency and degree or amount of the information detail to gather of the running application) expressed as rules. Essentially, the dynamic configuration acts as a filter to define the type and degree of information to capture. The client library 320 inspects the executable code to determine portions of the code to instrument based on the rules or heuristics of the dynamic configuration. Capture points of the runtime application are implemented as callbacks to the client library 320 which, as noted, are registered with the runtime system executing the user application 220 and invoked according to the dynamic configuration. The dynamic configuration may be loaded from various sources, such as from the agent 330, the APS infrastructure 350, and/or via user-defined sources such as files, environment variables and graphically via the UI infrastructure 360.

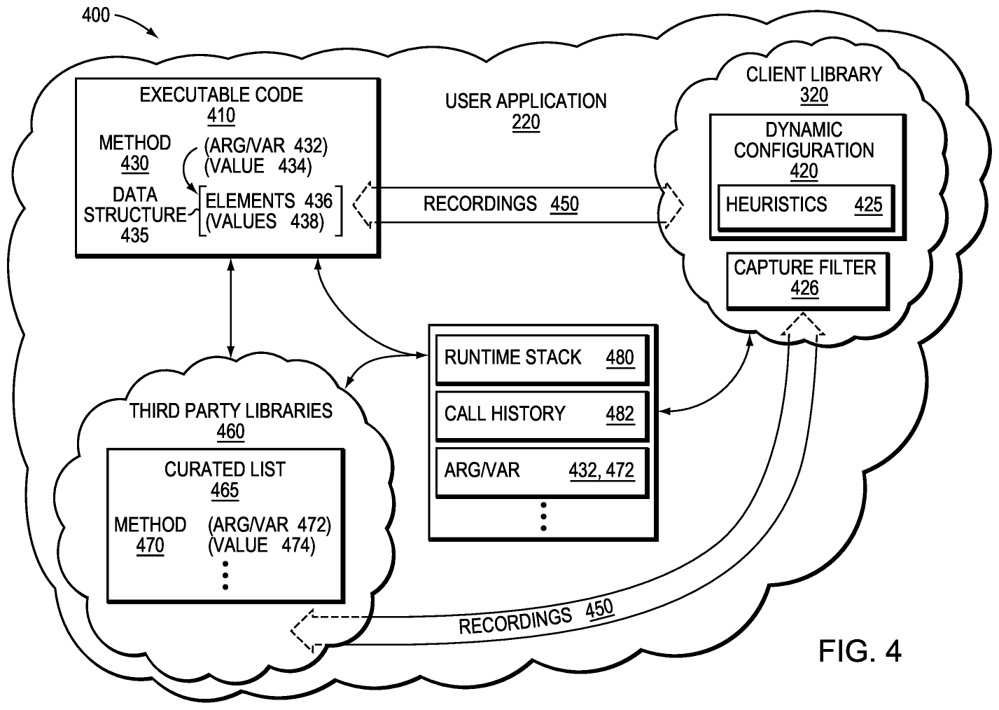

FIG. 4 illustrates a workflow 400 for instrumenting executable code 410 using a dynamic configuration 420 in accordance with instrumentation recording capture. Since there is only a finite amount of processing resources available for the client library 320 to perform its work, use of the processing resources may be optimized in accordance with the dynamic configuration 420, which describes a degree of fidelity of executable code 410 and information to capture at runtime as recordings, including traces, of the executing methods and data of the executable code. In one or more embodiments, default rules or heuristics 425 of the configuration 420 are employed to dynamically capture the recordings 450, wherein the default heuristics 425 may illustratively specify capture of (i) all methods 430 of the executable code 410 as well as (ii) certain dependencies on one or more third-party libraries 460 that are often mis-invoked (i.e., called with incorrect parameters or usage). A capture filter 426 is constructed (i.e., generated) from the dynamic configuration based on the heuristics. Changes to the dynamic configuration 420 may be reloaded during the capture interval and the capture filter re-generated. In this manner, the executable code 410 may be effectively re-instrumented on-demand as the capture filter screens the recordings 450 to capture.

Illustratively, the capture filter 426 may be embodied as a table having identifiers associated with methods to instrument, such that presence of a particular identifier in the table results in recording capture of the method associated with the identifier during the capture interval. That is, the capture filter is queried (e.g., the capture table is searched) during the capture interval to determine whether methods of the event driving the capture interval are found. If the method is found in the capture filter 426, a recording 450 is captured (i.e., recorded). Notably the method identifiers may depict the runtime system representation of the method (e.g., symbols) or a memory address for a compiled user application and runtime environment. In an embodiment, the capture filter may be extended to include capture filtering applied to arguments, variables, data structures and combinations thereof.

A default dynamic configuration is based on providing a high fidelity (i.e., capture a high recording detail) where there is a high probability of error. As such, the dynamic configuration may trade-off “high-signal” information (i.e., information very useful to debugging, analyzing and resolving errors) against consistently capturing a same level of detail of all invoked methods. For example, the third-party libraries 460 (such as, e.g., a standard string library, regular expression library, or commonly used framework) are typically widely used by software developers and, thus, are generally more reliable and mature than the user application 220 but are also likely to have incorrect usage by the user application. As a result, the heuristics 425 primarily focus on methods 430 of the user application's executable code 410 based on the assumption that it is less developed and thus more likely where errors or failures are to arise. The heuristics 425 (and capture filter 426) are also directed to tracing invocation of methods of the third-party libraries 460 by the user application via a curated list 465 of methods 470 of the third-part library having arguments/variables (arg/var) 472 and associated values 474 deemed as valuable (high-signal) for purposes of debugging and analysis. Notably, the curated list 465 may be folded into the capture filter 426 during processing/loading of the dynamic configuration 420. That is, the curated list includes high-signal methods of the third-party library most likely to be mis-invoked (e.g., called with incorrect calling parameters) and, thus, benefits debugging and analysis of the user application 220 that uses the curated high-signal method. The technique utilizes the available processing resources to capture these high-signal method/value recordings 450.

Illustratively, the client library 320 may examine a language runtime stack 480 and associated call history 482 using, e.g., inspection APIs, to query the runtime system during a capture interval to gather symbolic information, i.e., symbols and associated source code (when available), from the runtime system 240, invocations of methods 430, 470, associated arguments/variables 432, 472 (including local and instance variables), return values 434, 474 of the methods, and any exceptions being raised. Notably, the gathered symbolic information of a captured recording may include one or more of (i) high-level programming text processed by the runtime system, which may be derived (generated) from source code stored in repositories, and (ii) symbols as labels representing one or more of the methods, variables, data and state of the executable code. When an exception is raised, the client library 320 captures detailed information for every method in the stack 480, even if it was not instrumented in detail initially as provided in the dynamic configuration 420. That is, fidelity of recording capture is automatically increased during the capture interval in response to detecting a raised exception. Note that in some embodiments, this automatic increase in recording capture detail may be overridden in the dynamic configuration. In some embodiments, the runtime system executable code 410 may have limited human readability (i.e., may not be expressed in a high-level programming language) and, in that event, mapping of symbols and references from the executable code 410 to source code used to generate the executable code may be gathered from the repositories by the APS infrastructure 350 and associated with the captured recording.

The client library 320 may also inspect language runtime internals to determine values of data structures used by the application 220. In an embodiment, the dynamic configuration 420 for data structures 435 may involve “walking” the structures and capturing information based on a defined level of nesting (e.g., a nested depth of the data structures) which may be specified per data structure type, instance and/or method as provided in the dynamic configuration 420. As stated previously for language implementations that do not provide first-class callback support, a compiler may be modified to insert callbacks as “hooks” such that, when processing the executable code 410, the modified compiler may generate code to provide initial signals passed in the callbacks to the client library 320 which may inspect the stack 480 directly (e.g., examine memory locations storing the stack). In other embodiments, the client library may add callbacks at runtime in the executable code via proxy methods (i.e., wrapping invocations of the methods to include the callbacks at entry and/or exit of the methods).

In an embodiment, the client library 320 collects (captures) signals from the recordings 450 (recording signal information) such as (i) method invoked, i.e., a method for which the exception occurred, (ii) method source location, (iii) stack trace (i.e., serial order of method calls), (iv) operation name, i.e., a name of operation for which the exception occurred, (v) method arguments, (vi) local variable values, (vii) return values, (viii) any associated exception, (ix) any exception state of values collected, (x) duration information (e.g., an execution time of the method), and (xi) an executed branch of a conditional. Notably, for a recording capturing an anomaly (e.g., an exception) an increased fidelity of information capture may be made, such as gathering all parameters of the invoked method and deeper nested depth of data structures. The client library 320 sends the recording signal information to the APS infrastructure 350 of the investigative platform 300 for analysis, processing and display on the UI infrastructure 360.

Illustratively, the UI of infrastructure 360 is focused on displaying the code's behavior (i.e., how the code executes) rather than the code structure (i.e., how the code was written), the latter of which is the primary model by which users typically examine files of code using existing observability tools and visual text editors. A typical code behavior paradigm involves execution of a few lines of code from a first file that results in a call to a method from a second file and execution of a few lines of code from the second file. The UI of the technique is directed to visualizing this code execution paradigm, which is not generally available with existing tools, including those for observability and debugging. Rather these existing tools enable users to observe “proxy” information regarding code execution through, e.g., examination of logs, traces of code and source code, to construct a rough approximation of code behavior. The logs are linked to randomly captured log statements (events) that do not describe how the events interrelate or connect. As for traces, these existing tools do not capture all of the method calls and, for those tools that do capture them, the capture is not in an “always on” manner. Moreover, the existing tools that may be used in an “ad hoc” manner do not capture all of the data, i.e., the captured data set is substantially small and incomplete for visualization purposes, even for a trace.

In contrast, the technique described herein improves development and debugging of program code using a data collection and display capability embodied as a call graph configured to encompass a complete set of captured data as a recording for visualization on the UI. Visualization of the recording provides a user with context for all data flowing through the code execution. As described further herein, a feature of the technique is the visualization (showing) of the recording's data set on a flexible side pane of the UI display screen.

In an embodiment, a recording is a faithful representation of code execution that includes trace data and application data embodied as one or more frames corresponding to code (i.e., one or more methods) and associated values as captured during code execution. That is, the recording is directed to capturing a faithful representation of code execution to allow subsequent inspection of code behavior, including events or significant occurrences, by a user that may not have known at the time of execution that the occurrences would subsequently be of interest. A method invocation (call) has arguments that are passed to the method and captured, i.e., the capture provides access to actual values of the arguments that are passed to the method. The capture for the method is referred to as a frame, i.e., a frame corresponds to code (e.g., a method) and its values. Other calls inside the frame are invoked and their called methods and arguments are captured. Notably, the return values and the return locations of called methods are also captured and displayed for the frame. In other words, critical information that is visualized on the UI includes not only the return values from each frame, but also the locations from which the calls in the frame returned, i.e., the values are visualized at the actual locations from which the calls returned.

According to the technique, the UI displays the captured recording of code execution in the form of a call graph that illustrates (i.e., visually depicts) the frames as corresponding code of the invoked methods and values of the frames, in context and independent of source code layout. That is, the frames representing executed methods (code) are displayed individually with their associated source code and values of parameters at invocation without unnecessary showing of uninvoked, albeit related, code that may reside in a same source code file. In an embodiment, the call graph 180 is essentially a representation of a data structure that is traversed in a visual manner where synchronous method calls are displayed simultaneously on the UI display screen in a positional orientation following their flows. Note that the unlike conventional debugging and observability tools employing a call stack containing only one sequence of parent relationships of calls at an instant in time, the call graph disclosed herein encompasses a history and relationships (through parenting and sequencing/timing information) of all calls in an operation, both synchronous and asynchronous. As such, a call graph for an operation contains the information to construct every call stack which existed at every instant during that operation. Particularly, frames executed synchronously are visually grouped in a window so that other frames executed asynchronously to the former frames are visually grouped in a different (separate) window that may be dynamically brought up as the user selects the calls. Return paths of values are further displayed to illustrate the locations from which the calls (frame) returned. Notably, exception handling is precisely recorded in the call graph that allows for efficient root cause determination unlike conventional tools that merely capture exception call stacks that often require additional forensics for root cause determination. The technique provides a UI visual tool for traversing the call graph, which is illustratively constructed during capture of the code execution. In addition, a frame and its associated values or parameters may be selected (clicked on) to show a full associated capture to strike a balance between being able to visualize (i) a flow of the code and its execution, and (ii) additional details of the parameters associated with the code execution. Notably, an initial frame may be displayed based on a default selection from the frame graph navigator.

For example, the user may select (click on) a frame to visualize the execution of code on the UI in an organized manner (e.g., synchronously executed methods grouped by a stack of windows layered according to sequential order of execution) across different methods that were invoked (called) during execution of the code along with their associated call parameters, wherein asynchronously invoked methods are visualized distinctively (e.g., grouped as a separately displayed stack of windows). The user may also click on a call of the frame within the recording to visualize context of the recording as, e.g., parameters flowing through different frames displayed at the same time. In addition to parameters called when entering a frame, further details of the parameters may be displayed in a side pane of the UI including, e.g., parameters in the frame and parameters returned from the frame. In contrast to traditional debugging that typically displays extraneous information by showing entire text files of code including related, albeit uninvoked, code for the frame, the UI displays relevant invoked code for the frame and simultaneously displays, in context, all parameters and call stacks of code execution as recorded, which may include code of methods in different files with relevant linking.

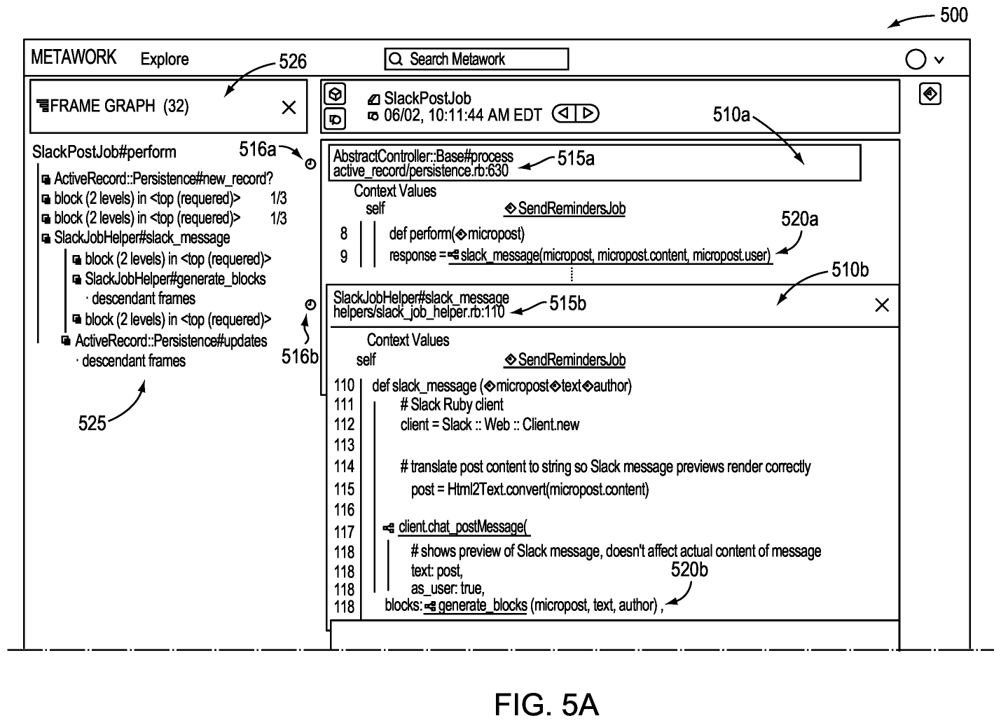

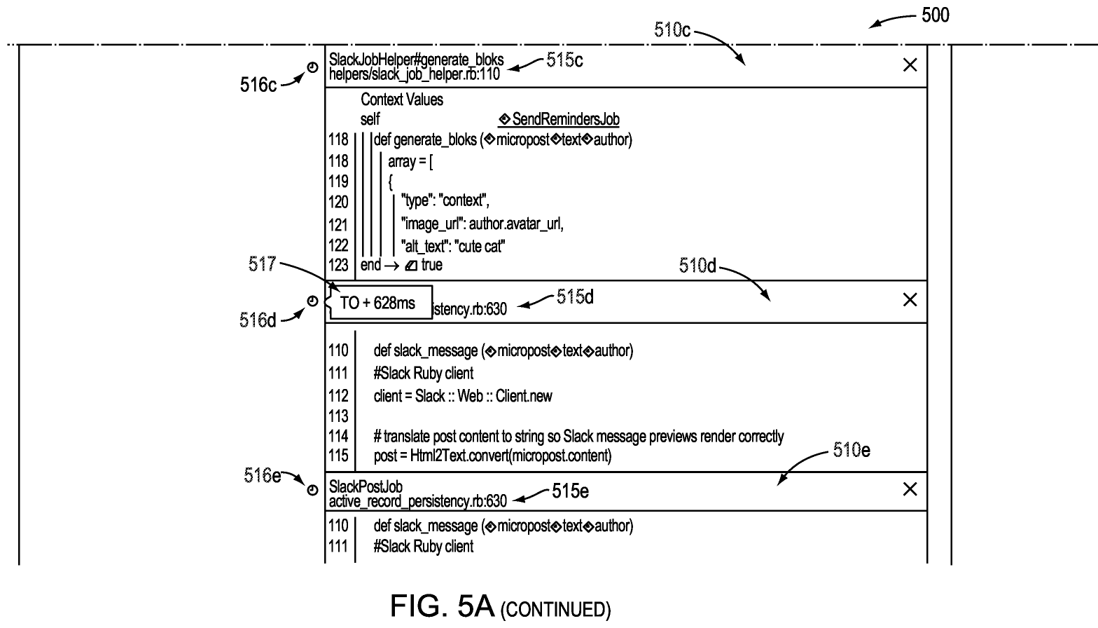

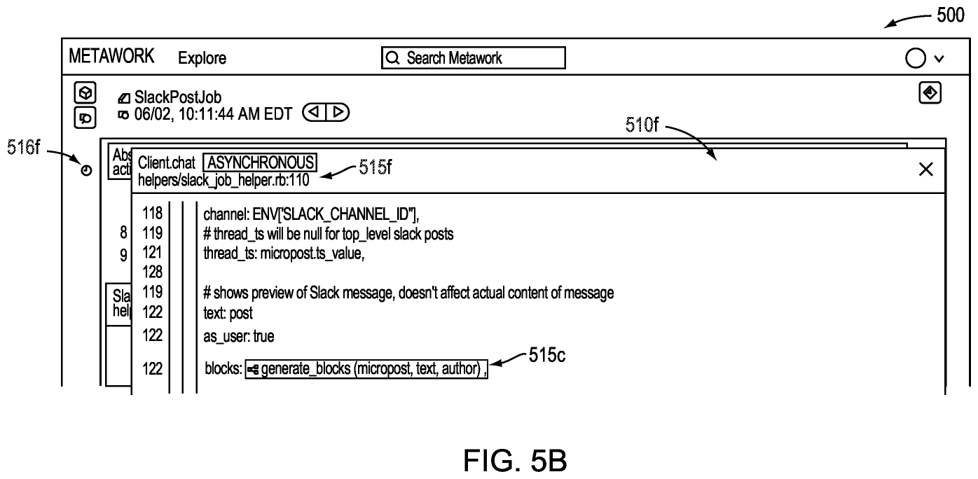

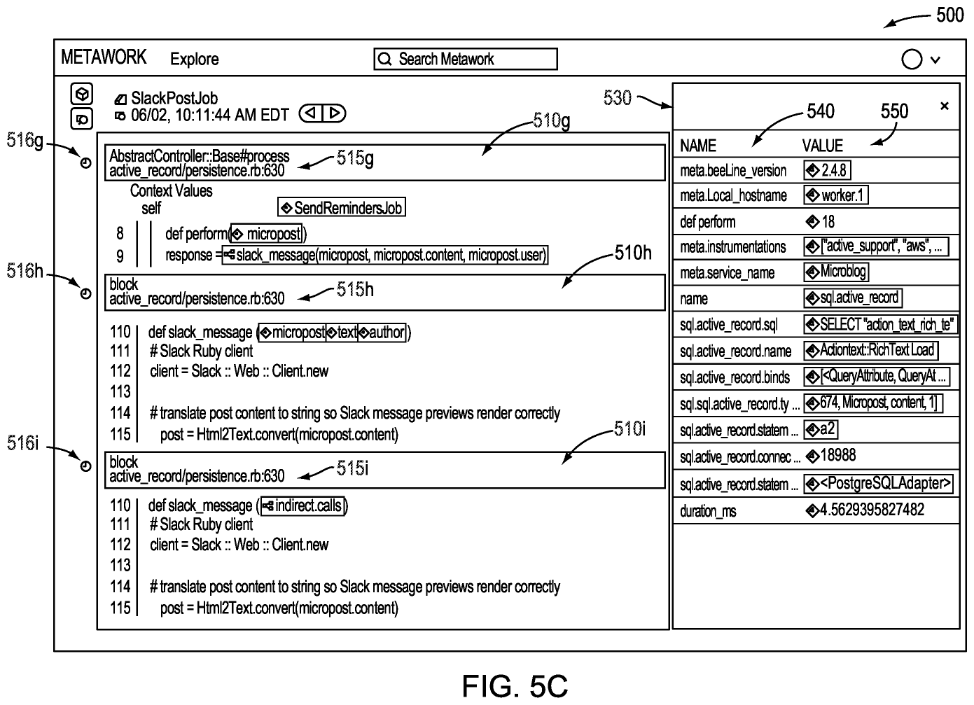

FIGS. 5A-5C are screenshots of a UI embodiment that displays recordings of code execution on a standard UI in accordance with a code execution recording visualization technique. In particular, FIG. 5A depicts a UI embodiment of synchronously executed code grouped according to sequential order of execution. Illustratively, each window 510a-i depicts (renders) information of a frame that is captured on synchronous method invocation within a current call stack. A frame graph navigation window 526 depicts a list of frames 525 in order of execution. Individual frames from the list may be selected resulting in a frame window 510a-i being displayed. Window titles 515a-h of each frame depict the invoked method of the frame and associated source code reference (e.g., file path and line number). Notably, each window 510 depicts only the relevant source code pertaining to the invoked method without extraneous display of uninvoked methods within the frame. In some embodiments (not shown) additional context may be shown along with the source code. Highlighted code lines 520 a,b (graphically emphasized lines of code) in the frame indicate invocation of a subsequent frame (i.e., call to the next method), which may be displayed vertically in a partially overlapping window on top of the previous window (i.e., “stacked”) to indicate a sequence of execution graphically so as to depict synchronous invocations as additional frames are “pushed” on the current call stack. In contrast, asynchronous method invocations that logically create (e.g., in a runtime implementation) a separate call stack are depicted in a separate window 510f as illustrated in FIG. 5B. Further, specific metadata (e.g., execution time) of each frame may be examined using an associated icon 516a-i adjacent to the window. Illustratively, a small callout window 517 appears displaying a time of execution for frame 510d when a time icon 516d is selected.

Because modern software development is not just linear, single-threaded code, the UI also addresses multi-threaded, asynchronous background worker queue cases as well, since they are some of the most challenging as multiple events/actions occur in concurrently, possibly in parallel. Notably, an asynchronously invoked frame includes an indicator (e.g., “ASYNCHRONOUS” in the window title) showing that the frame was asynchronously invoked. Further, the asynchronous frame (window 5100 also includes a reference to the caller as a highlighted method name 515c so that asynchronous call flows may be readily understood. Traversal of the frames may be performed by selecting (clicking on) the frame triggers (e.g., highlighted source code line 510) to bring up a next frame window which includes synchronous execution on the same call stack (depicted as a partially overlapping window) or as the separate call stack displaying the asynchronous invocation. From the user's perspective, the two call stacks execute in concurrently (e.g., on separate threads) within a larger call graph, which illustrates the method invocation from which the separate (asynchronous) call stack originated. The call graph is configured to intuitively organize the asynchronous invocation, which is generally difficult to visually depict, particularly with respect to proper linking and parenting of the asynchronous execution to its current method invocation (frame).

In this manner, multiple call stacks may be displayed as the call graph. For example, a first call stack may invoke an asynchronous call to a method, which transitions the user from the main call stack “view” into an asynchronous call manifesting as multiple call stacks of code execution. This is visualized on the UI as the point at which code execution (e.g., code line 520b of FIG. 5A) transitioned (jumped) into the asynchronous call, resulting in a call graph of multiple call stacks that may eventually merge (i.e., window 510f disappears). Therefore, the UI is configured to depict when the call stack evolves into a call graph (i.e., a multiple call stack graph) having multiple call stacks.

In an embodiment, the UI may display code execution as the call graph having asynchronous execution features of programming languages or thread pools and worker queues, whose execution supports multiple stacks or a single-threaded call stack. The technique may also display details of the frame and associated code along with parameters, values and related metadata as illustrated in FIG. 5C. These may be depicted in an adjoining window along with relevant metadata displayed as a set of key-value pairs (e.g., name 540 and value 550), such as a remote database query including a structured query language (SQL) command and a duration for retrieving the information.

In sum, the technique may model code execution of a recording as a call graph having asynchronous nodes or execution entities (e.g., threads, processes, remote procedure calls) executing concurrently. The call graph may be displayed as different windows (each representing a different execution entity) using various coloring or highlighting in the code to demonstrate when the entity has been invoked (executed). The user may drill down and open a window of (i) asynchronous code executing concurrently or (ii) asynchronous code that behaves similar to synchronous code. Such an example may be invocation of an execution entity in the context of a base method as, e.g., a process or thread as an active invocation of another call stack, and a call to a particular library that a kernel asynchronously executes concurrently. The user may view the latter as synchronous execution waiting on a result and the main thread of the base method as essentially linear, synchronous execution. In other words, there is a distinction between invoking a call stack which executes concurrently (i.e., spawning an execution entity) versus issuing a call which may spawn an execution entity “behind the scenes” of which the user is unaware while waiting on the result.

Advantageously, the UI visualization feature of the technique described herein provides a user with a concrete visual representation of code execution in an organized flow that enables the user to walkthrough the recording in the same manner in which the code was executed. The display and analysis of such concrete representation of information provides an enhanced observability and visualization tool that displaces user experiences around conventional metrics dashboards. By examining and analyzing sample sets of recordings, the user experience is greatly increased as compared to conventional observability or debugging tools.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks, and/or electronic memory) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
instrumenting executable code of an application to capture execution of the application as a recording of code execution on a computer node having a memory;
capturing the recording of code execution during a callback to a client library, wherein the recording includes one or more of methods and associated parameters of methods invoked during the code execution,
displaying via a user interface (UI), a call graph of the recording of code execution visually grouped according to synchronous invocation of the methods each depicted in a window showing source code of a respectively invoked method, wherein the windows are visually stacked based on a sequence of the recording; and
separately visually grouping asynchronous invocation of at least one of the method having an indicator that the at least one method is asynchronously invoked.

2. (canceled)

3. The method of claim 2 wherein the separate visual grouping includes a separate window the includes a highlighted reference to a caller of the asynchronous invocation of the at least one method.

4. The method of claim 1 wherein displaying the call graph further comprises:
displaying a structure and values of a parameter corresponding to the invoked method depicted in the window selected by a user.

5. The method of claim 4 wherein the displayed parameter includes metadata related to the parameter.

6. The method of claim 5 wherein the metadata includes database information from which the displayed parameter value is obtained.

7. The method of claim 1 wherein the shown source code depicted in the respectively invoked method is without displaying source code of uninvoked methods.

8. The method of claim 1 wherein each of the depicted windows include a reference to a source code file and line number where the respectively invoked method is found.

9. The method of claim 1 wherein each of the shown source code depicted in each of the windows includes a highlighted line of source code where invoked methods are called.

10. The method of claim 1 wherein the call graph of the recording of code execution includes a display of timing information of the invoked methods.

11. A non-transitory computer readable medium including program instructions for execution on a computer node having a memory, the program instructions configured to:
instrument executable code of an application to capture execution of the application as a recording of code execution on the computer node;
capture the recording of code execution during a callback to a client library, wherein the recording includes one or more of methods and associated parameters of methods invoked during the code execution;
display via a user interface (UI), a call graph of the recording of code execution visually grouped according to synchronous invocation of the methods each depicted in a window showing source code of a respectively invoked method, wherein the windows are visually stacked based on a sequence of the recording; and
separately visually group asynchronous invocation of at least one of the methods having an indicator that the at least one method is asynchronously invoked.

12. (canceled)

13. The non-transitory computer readable medium of claim 11, wherein the visually separate grouping includes a separate window that includes a highlighted reference to a caller of the asynchronous invocation of the at least one method.

14. The non-transitory computer readable medium of claim 11, wherein the program instructions configured to display the call graph comprise program instructions further configured to display a structure and values of a parameter corresponding to the invoked method depicted in the window selected by a user.

15. The non-transitory computer readable medium of claim 11, wherein the displayed parameter includes metadata related to the parameter.

16. The non-transitory computer readable medium of claim 11, wherein the metadata includes database information from which the displayed parameter value is obtained.

17. The non-transitory computer readable medium of claim 11, wherein the shown source code depicted in the respectively invoked method is without displaying source code of uninvoked methods.

18. The non-transitory computer readable medium of claim 11, wherein the program instructions configured to capture recording of code execution during a callback comprise program instructions further configured to modify one of a programming language runtime or a compiler to insert the callback.

19. The non-transitory computer readable medium of claim 11, wherein each of the shown source code depicted in each of the windows includes a highlighted line of source code where invoked methods are called.

20. A system comprising:
a computer node having a memory and a processor, wherein the processor executes program instructions configured to,
instrument executable code of an application to capture execution of the application as a recording of code execution on the computer node;
capture the recording of code execution during a callback to a client library, wherein the recording includes one or more of methods and associated parameters of methods invoked during the code execution;
display, via a user interface, a call graph of the recording of code execution visually grouped according to synchronous invocation of the methods each depicted in a window showing source code of a respectively invoked method, wherein the windows are visually stacked based on a sequence of the recording, and
separately visually group asynchronous invocation of at least one of the methods having an indicator that the at least one method is asynchronously invoked.
